(19) United States
(12) Patent Application Publication
(10) Pub. No.: US 2005/0062916 A1
(43) Pub. Date: Mar. 24, 2005

(54) Laminated phase plate and optical pickup using thereof

(75) Inventors: Hiroshi Matsumoto, Kouza-gun (JP); Masayuki Ooto, Kouza-gun (JP); Satoshi Kaizawa, Kouza-gun (JP)

Correspondence Address: KODA & ANDROLIA, 2029 CENTURY PARK EAST, SUITE 1430, LOS ANGELES, CA, 90067-3024, US

(73) Assignee: Toyo Communication Equipment Co., Ltd.

(21) Appl. No.: 10/852,809

(22) Filed: May 25, 2004

(30) Foreign Application Priority Data
May 30, 2003 (JP) 2003-155618

(51) Int. Cl. G02F 1/1335

(52) U.S. Cl. 349/117

(57) ABSTRACT

It is an object of the present invention to provide a wave plate which functions as a 1/4 wave plate where wave front aberration, temperature characteristics, and incident angle dependence are improved with respect to a plurality of wavelengths of an optical pickup unit or the like compatible with DVD and CD, and an optical pickup using the wave plate. In the laminated wave plate where a wave plate whose phase difference is a with respect to a monochromatic light of a wavelength λ and a wave plate whose phase difference is β are laminated so that their optical axes cross, and which the laminated wave plate functions as the 1/4 wave plate, a relationship between the phase difference a and the phase difference β satisfies the following condition: α=πn β=πm/2 however, n>1, and m>1 a material of one wave plate is a film having birefringence characteristics and a material of the other wave plate is quarts.

### BACKGROUND OF THE INVENTION

1. Field of the Invention

The present invention relates to a laminated wave plate that enables recording and reproducing information from an optical recording medium using lights of different wavelengths, and an optical pickup using thereof.

2. Background Art

Optical disk units, which records and reproduces information relating to music and images from CDs, DVDs and the like using laser beams such as a linearly polarized light and a circularly polarized light, are widely utilized. The demands for downsizing of units are increasing along with the popularization of optical disk units, which are compatible with CDs and DVDS. Consequently, the downsizing of optical pickup units has been made by simplifications such as decreasing the number of optical parts used therefore.

DVDs have a specification such that information of images and sounds for two or more hours can be stored in one disk, and thus their recording density is higher than that of CDs. Accordingly, a reproduction wavelength of the DVDS becomes 655 nm, which is shorter than the wavelength 785 nm of CDs. The optical pickup units compatible with DVDs and CDs inevitably require two kinds of wavelengths, but recently wide-band wave plates which functions as a wave plate at two different wavelengths are proposed. Consequently, the optical pickup units, which conventionally require a two-system pickup, can be constituted by a one-system pickup.

Polarized lights to be used for the optical pickups are explained below. “Light” in general is one of waves which are called as electromagnetic waves, a plane including a light advancing direction and a magnetic field is called as a polarization plane, and a plane including a light advancing direction and an electrical field is called as a vibration plane. An occasion on which directions of the polarization plane are aligned is called as a polarized light. Further, the polarized light where polarization plane is limited to one plane is called as a linearly polarized light, and the linearly polarized light includes a P-polarized light as a component which vibrates horizontally with respect to a plane including incident light beams and a normal of an incident plane and an S-polarized light as a component which vibrates vertically.

A polarized light where an electrical field vector in a certain position rotates with time is generally called as an elliptically polarized light. When a front end of the electrical field vector is projected onto a plane vertical to the light advancing direction, its trajectory becomes a circular one. This is particularly called as a circularly polarized light.

Japanese Patent No. 3174367 (page 4, FIG. 1) and Japanese Laid-open No. HEI 10-068816 (page 5, FIG. 1) disclose a wide-band ¼ wave plate in which birefringence films having a phase difference of 180° and having a phase difference of 90° are laminated.

In this wide-band ¼ wave plate, however, since the birefringence films are used as a material, the following problem arises. FIG. 10 is a diagram showing optical characteristics of a wide-band ¼ wave plate 34 in which a glass substrate 33 (refractive index: na) which functions as a supporting substrate is laminated on a birefringence film 31 (refractive index: nc) having a phase difference of 90° by using an adhesive 32 (refractive index: nb). The birefringence film 31 is constituted so that two birefringence films are laminated.

An area of the film layer 31 and the adhesive layer 32 of the wide-band ¼ wave plate 34 has weak rigidity and thus is easily deformed. For this reason, when a stress or the like is applied thereto from the outside, a sectional shape shown in FIG. 10 is provided. In this case, when a wave front 35 of light transmits through the wide-band ¼ wave plate 34, the following optical phenomenon occurs.

On an optical path 36, an optical path length L(36) of the wide-band ¼ wave plate 34 while a linearly polarized light S (S-polarized light) enters HA1 of the wide-band ¼ wave plate 34 and is emitted as a circularly polarized light from HC1 is obtained as follows:
L(36)=LA1×na+LB1×nb+LC1×nc
On the other hand, on an optical path 37, an optical path length L(37) of the wide-band ¼ wave plate 34 while the linear polarized light S enters HA2 of the wide-band ¼ wave plate 34 and is emitted as a circularly polarized light from HC2 is obtained as follows:
L(37)=LA2×na+LB2×nb+LC2×nc
Since LA1≈LA2 and LC1≈LC2, a difference ΔL between the optical paths 36 and 37 when the light passes through the wide-band ¼ wave plate 34 is obtained as follows:
ΔL=(LB1−LB2)×nb
A phase of a circularly polarized light 38 on the optical path 36 emitted from the wide-band ¼ wave plate 34 is delayed by ΔL with respect to a phase of a circularly polarized light 39 on the optical path 37 emitted from the wide-band ¼ wave plate 34. When the wave front 35 enters the wide-band ¼ wave plate 34, therefore, wave front aberration occurs, so that a distorted wave front 40 is emitted.

As shown in FIG. 11, when the wide-band ¼ wave plate 34 is used in the optical pickup, the wave front 35 passes through the wide-band ¼ wave plate 34 so as to be the distorted wave front 40. The wave front 40 is then converged by an objective lens 41, so as to be emitted onto a pit 42 of the disk For example, a first, a second, and a third optical paths are focused on points 43, 44, and 45, respectively. Therefore, those points are not focused on the pit 42. In order to solve this problem, both principal planes of the wide-band ¼ wave plate are sandwiched by supporting boards such as glass substrates, as a quick-fix.

A film has large thermal expansion and thus when the temperature changes, the film is distorted and the optical characteristics are deteriorated. In order to solve this problem, a sapphire or a quarts substrate having high thermal conductivity is laminated as a radiator plate on the wide-band ¼ wave plate, and with this configuration, a heat radiation effect is heightened for releasing heat from the film.

When, however, the glass substrate is laminated as the supporting board, or the quarts or sapphire substrate is laminated as the radiator plate on the wide-band ¼ wave plate made of film, cumbersome works are required for mass production, and a new problem of a rise in the cost or the like arises.

As a unit that can simultaneously solve the problems of the wave front aberration and the deterioration of the optical characteristics due to heat, the wide-band ¼ wave plate constituted by laminating a quartz substrate having a phase difference of 180° and a quarts substrate having a phase difference of 90° is proposed.

FIGS. 7(a) and 7(b) are views showing a constitution of a quarts wide-band ¼ wave plate 1, in which FIG. 7(a) is a plan view which the quarts wide-band ¼ wave plate 1 is viewed from an incident direction, and FIG. 7(b) is a perspective general view of the constitution thereof. In the quarts wide-band ¼ wave plate 1, a quarts wave plate 2 in which a phase difference is 180° and in-plane rotational azimuth is 15° and a quarts wave plate 3 in which a phase difference is 90° and an azimuth is 75° with respect to wavelength 785 nm are laminated so that their crystal optical axes 4 and 5 cross at an angle of 60°. In such a manner, a laminated wave plate which functions as the ¼ wave plate over a wide wavelength band is constituted. That is to say, when a linearly polarized light 6 enters the quarts wide-band ¼ wave plate 1, the phase shifts by 90° until the light reaches the emission plane. Accordingly, the linearly polarized light 6 becomes a circularly polarized light 7 so as to be emitted.

FIGS. 8(a) and 8(b) are graphs showing optical characteristics of the quarts wide-band ¼ wave plate 1, in which FIG. 8(a) is a graph of a wavelength dependence thereof, and FIG. 8(b) is a graph of an incident angle dependence thereof. As to the wavelength dependence of the quarts wide-band ¼ wave plate 1, the phase difference is 90° in a wide band, and thus the ¼ wave plate functions properly. As to the incident angle dependence, however, as the incident angle becomes larger, the phase difference further shifts from 90°. Thus, a problem lies with the incident angle dependence.

The present invention has been achieved in order to solve the above problems. It is an object of the invention to provide a wave plate which functions as a ¼ wave plate whose wave front aberration, temperature dependence, and incident angle dependence are improved with respect to a plurality of wavelengths in an optical pickup unit or the like compatible with DVDs and CDs, and an optical pickup using the wave plate.

### SUMMARY OF THE INVENTION

In order to achieve the above object, a first aspect of the present invention provides a laminated wave plate in which a wave plate whose phase difference is α with respect to a monochromatic light of a wavelength α and a wave plate whose phase difference is β are laminated so that their optical axes cross, and which functions as ¼ wave plate, wherein a relationship between the phase difference α and the phase difference β satisfies the following condition:
α=πn
β=πm/2
however, n>1, and m>1
   a material of one wave plate is a film having birefringence characteristics and a material of the other wave plate is quarts.

A second aspect of the present invention provides an optical pickup constituted so that a first linearly polarized light of a first wavelength and a second linearly polarized light of a second wavelength emitted from a light source pass through a wave plate, wherein the wave plate is a laminated wave plate in which a wave plate whose phase difference is a with respect to a monochromatic light of the wavelength λ and a wave plate whose phase difference is β are laminated so that their optical axes cross, and which the laminated wave plate functions as ¼ wave plate, a relationship between the phase difference a and the phase difference β satisfies the following condition:
α=πn
β=πm/2
however, n>1, and m>1
   a material of one wave plate is a film having birefringence characteristics and a material of the other wave plate is quarts.

A third aspect of the present invention provides the optical pickup according to the second aspect, wherein the first wavelength is 655 nm, and the second wavelength is 785 nm.

A fourth aspect of the present invention provides a laminated wave plate in which a quarts wave plate whose phase difference is 90° with respect to wavelength 785 nm and a film wave plate whose phase difference is 180° are laminated so that their optical axes cross and the laminated wave plate functions as a ¼ wave plate.

A fifth aspect of the present invention provides a laminated wave plate in which a quarts wave plate whose phase difference is 90° with respect to wavelength 785 nm and a film wave plate whose phase difference is 90° are laminated so that their optical axes cross and the laminated wave plate functions as a ¼ wave plate.

### BRIEF DESCRIPTION OF THE DRAWINGS

FIG. 1(a) and 1(b) are views for explaining a constitution of a laminated wave plate according to a first embodiment of the present invention, in which FIG. 1(a) is a plan view thereof from an incident direction, and FIG. 1(b) is a perspective general view thereof;

FIG. 2(a) and 2(b) are graphs of optical characteristics of the laminated wave plate according to the first embodiment of the present invention, in which FIG. 2(a) is a graph of a wavelength dependence thereof, and FIG. 2(b) is a graph of an incident angle dependence thereof;

FIG. 3(a) and 3(b) are views for explaining a constitution of a laminated wave plate according to a second embodiment of the present invention, in which FIG. 3(a) is a plan view thereof from an incident direction, and FIG. 3(b) is a perspective general view thereof;

FIG. 4(a) and 4(b) are graphs of optical characteristics of the laminated wave plate according to the second embodiment of the present invention, in which FIG. 4(a) is a graph of a wavelength dependence thereof, and FIG. 4(b) is a graph of an incident angle dependence thereof;

FIG. 5 is a perspective view for explaining a constitution of an optical pickup according to an embodiment of the present invention;

FIG. 6(a) and 6(b) are graphs showing optical characteristics of a first PBS and a second PBS to be used in the optical pickup according to the embodiment of the present invention;

FIGS. 7(a) and 7(b) are views showing a conventional laminated wave plate, in which FIG. 7(a) is a plan view thereof which is viewed from an incident direction, and FIG. 7(b) is a perspective general view thereof;

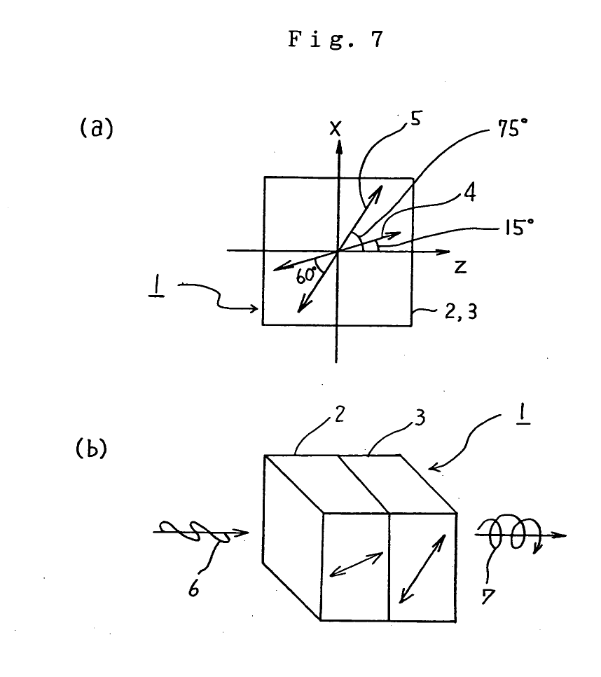

FIG. 8(a) and 8(b) are graphs showing optical characteristics of the conventional laminated wave plate, in which FIG. 8(a) is a graph of a wavelength dependence thereof, and FIG. 8(b) is a graph of an incident angle dependence thereof;

FIG. 9(a) and 9(b) are diagrams showing directions of an incident light towards a wave plate 8, in which FIG. 9(a) is a diagram of an angle ψ formed by a line obtained by projecting an optical axis of the incident light entering the wave plate onto a principle plane (z-x plane) of the wave plate and az-axis, and FIG. 9(b) is a perspective view of the optical axis of the incident light entering the wave plate;

FIG. 10 is a diagram for explaining an optical function of the conventional laminated wave plate; and

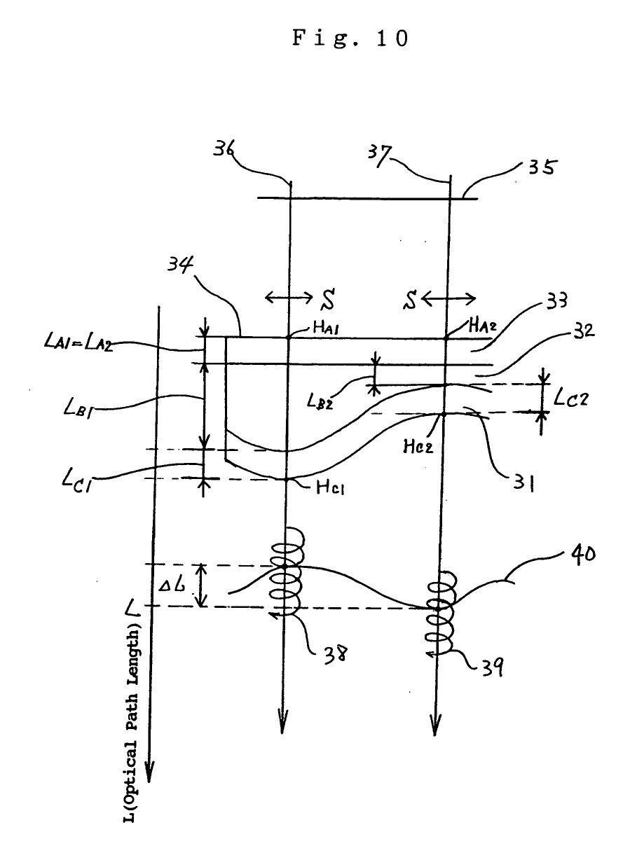

FIG. 11 is a diagram for explaining an optical function when the conventional laminated wave plate is used in an optical pickup unit.

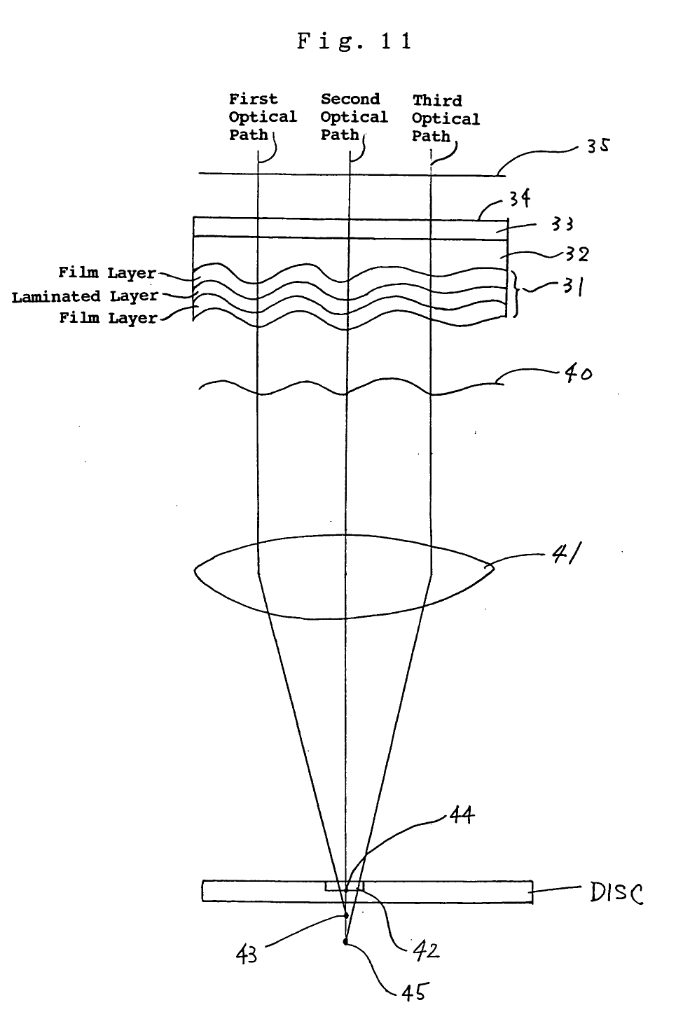

### DETAILED DESCRIPTION OF THE PREFERRED EMBODIMENTS

The present invention is explained based on the preferred embodiments shown in the accompanying drawings.

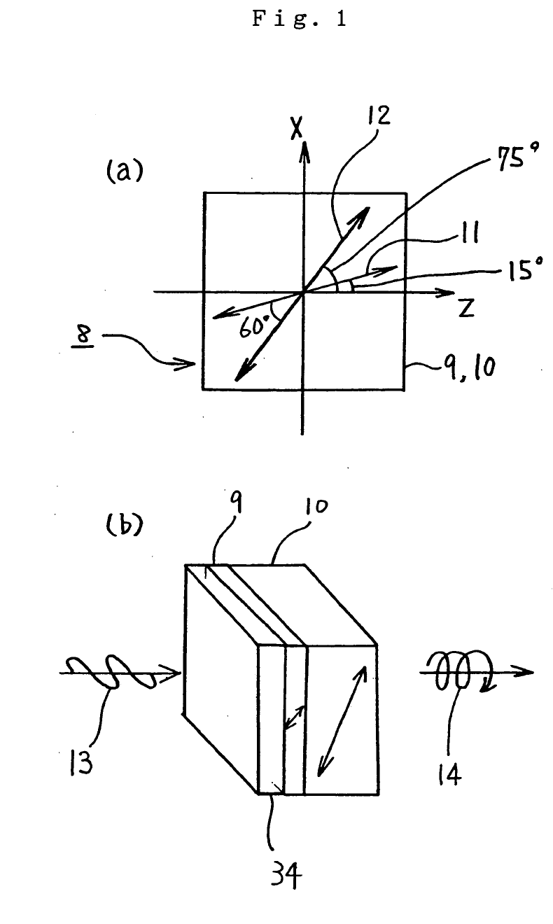

FIG. 1(a) and 1(b) are views showing a constitution of a laminated wave plate according to the first embodiment of the present invention, in which FIG. 1(a) is a plan view which the laminated wave plate is viewed from an incident direction, and FIG. 1(b) is a perspective general view thereof. The laminated wave plate 8 is constituted by laminating a film wave plate 9, in which a glass substrate 34 is used as a supporting substrate, a phase difference is 180° with respect to a wavelength of 785 nm and an in-plane rotational azimuth (hereinafter the azimuth) is 15°, and a quarts wave plate 10, in which a phase difference is 90° and an azimuth is 75°. At this time, their quarts optical axes 11 and 12 cross at an angle of 60°, and the laminated wave plate 8 functions as a ¼ wave plate over a wide wavelength band. That is to say, when a linearly polarized light 13 enters the laminated wave plate 8, the phase shifts by 90° until the light reaches an emission plane. For this reason, the linearly polarized light 13 is emitted as a circularly polarized light 14.

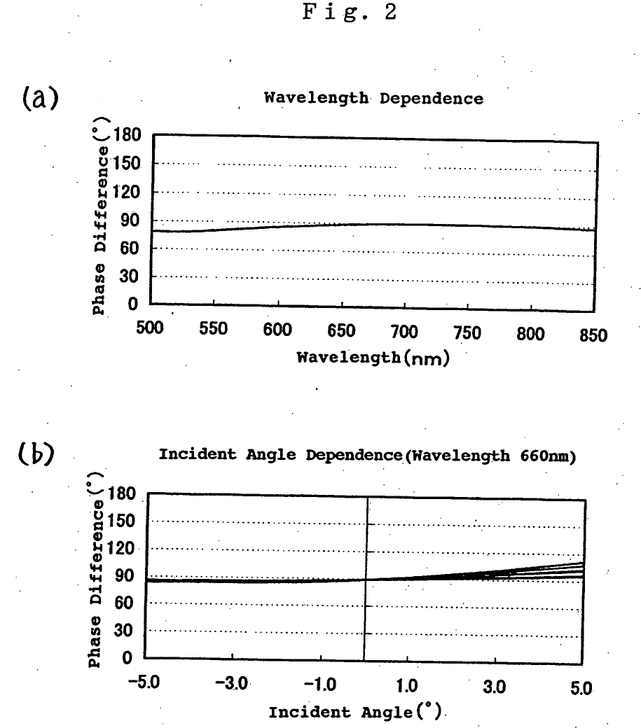

FIG. 2(a) and 2(b) are graphs of optical characteristics of the laminated wave plate 8, in which FIG. 2(a) is a graph of a wavelength dependence thereof, and FIG. 2(b) is a graph of an incident angle dependence thereof. It can be found that the phase difference is 90° over the wide wavelength band and the laminated wave plate 8 functions as a ¼ wave plate in the wavelength dependence of the laminated wave plate 8.

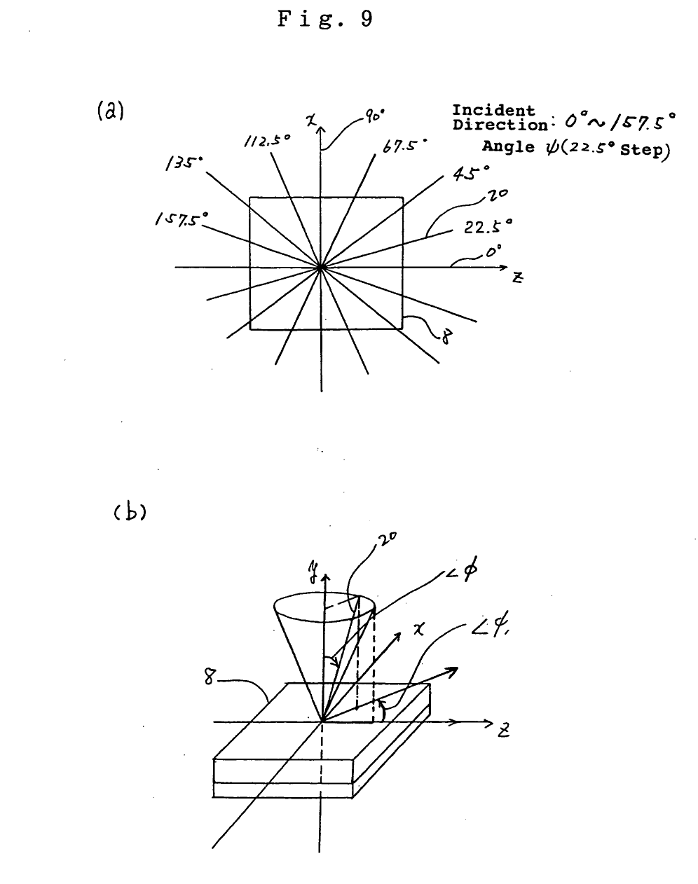

An attention is paid here to the incident angle dependence. FIG. 9(a) and 9(b) are diagrams showing directions of an incident light towards a wave plate 8, in which FIG. 9(a) is a diagram of an angle ψ formed by a line obtained by projecting an optical axis 20 of the incident light entering the wave plate 8 onto a principle plane (z-x plane) of the wave plate and a z-axis, and FIG. 9(b) is a perspective view of the optical axis 20 of the incident light entering the wave plate 8. φ represents an angle formed by the optical axis 20 of the incident light and a y-axis, namely, a so-called incident angle.

The angle ψ of 0° to 157.5° is simulated to be analyzed at every 22.5° step within a range ±5.0° of the incident angle φ. It is then verified that a shift from the phase difference 90° with respect to the incident direction becomes small, and the incident angle dependence is remarkably improved.

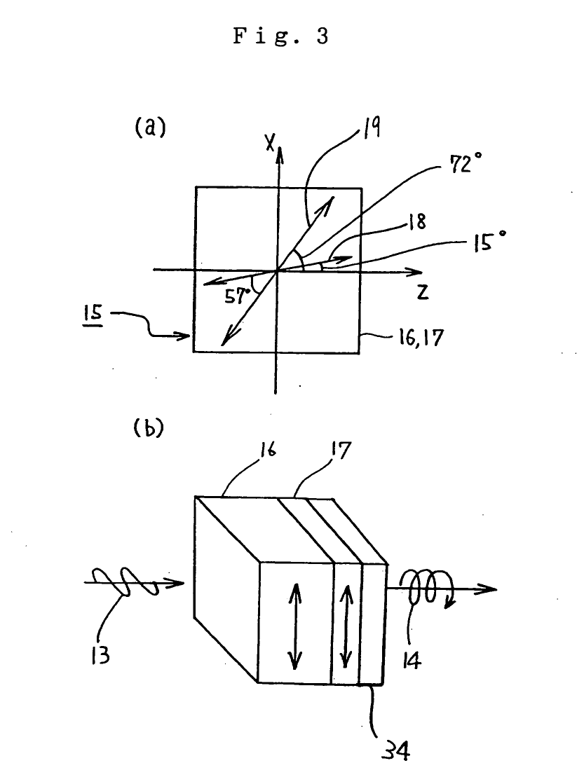

FIG. 3(a) and 3(b) are views showing a constitution of a laminated wave plate according to the second embodiment of the present invention, in which FIG. 3(a) is a plan view of the laminated wave plate from an incident direction, and FIG. 3(b) is a perspective general view thereof. The laminated wave plate 15 is constituted by laminating a quarts wave plate 16, in which a phase difference is 90° (secondary mode: 180°) with respect to a wavelength 785 nm and an azimuth is 15°, and a film wave plate 17, in which the glass substrate 34 is used as a supporting substrate, a phase difference is 90° and an azimuth is 72°. At this time, their quarts optical axes 18 and 19 cross at an angle of 57°, and the laminated wave plate 15 functions as a ¼ wave plate over a wide wavelength band. When the linearly polarized light 13 enters the laminated wave plate 15, the phase shifts by 90° until the light reaches the emission plane, and thus the linearly polarized light 13 is emitted as the circularly polarized light 14.

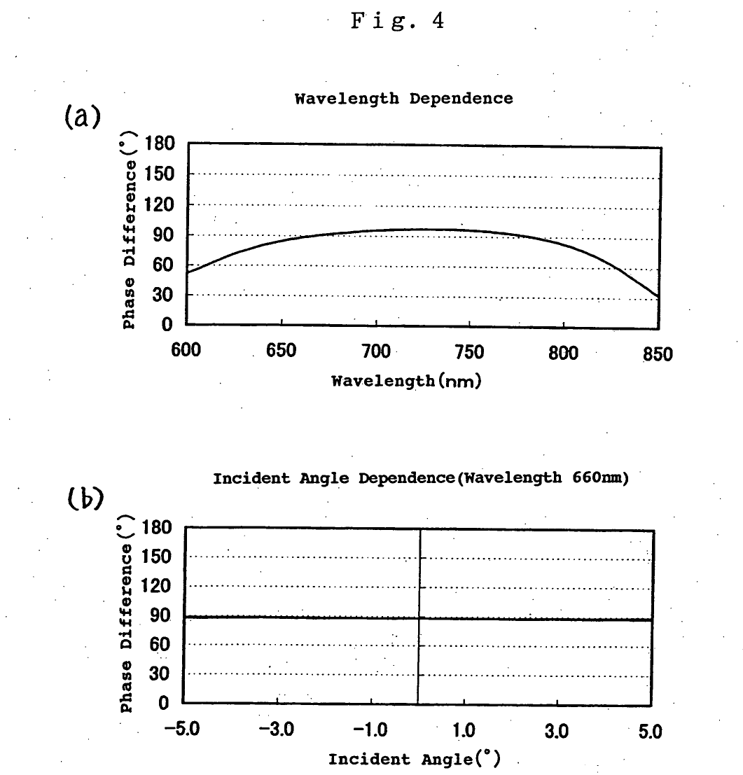

FIG. 4(a) and 4(b) are graphs of optical characteristics of the laminated wave plate 15, in which FIG. 4(a) is a graph of a wavelength dependence, and FIG. 4(b) is a graph of an incident angle dependence thereof. Simulations and analyses are carried out as to the wavelength dependence of the laminated wave plate 15, and it is found that the phase difference is 90° over the wide wavelength band (650 to 800 nm), and the laminated wave plate 15 functions as a ¼ wave plate.

As to the incident angle dependence, the angle ψ of 0° to 157.5° is simulated to be analyzed at every 22.5° step within a range ±5.0° of the incident angle φ. It is then verified that the phase difference does not shift from 90° with respect to the incident direction, a flat characteristic is obtained, and the incident angle dependence is remarkably improved.

The present inventors conducted simulations, analyses, and various experiments, and they found that following laminated wave plate which functions as a ¼ wave plate over the wide wavelength band and whose incident angle dependence is remarkably improved can be provided. This laminated wave plate is obtained by laminating a wave plate, in which a phase difference is a with respect to a monochromatic light of the wavelength λ, and a wave plate having a phase difference β so that their optical axes cross. A relationship between the phase difference α the phase difference β satisfies the following condition:
α=πn
β=πm/2
however, n>1, and m>1

As to materials, a film having birefringence characteristics is applied to one wave plate, and quarts are applied to the other wave plate.

An optical pickup which deals with two wavelengths using the laminated wave plate according to the present invention is explained below in detail.

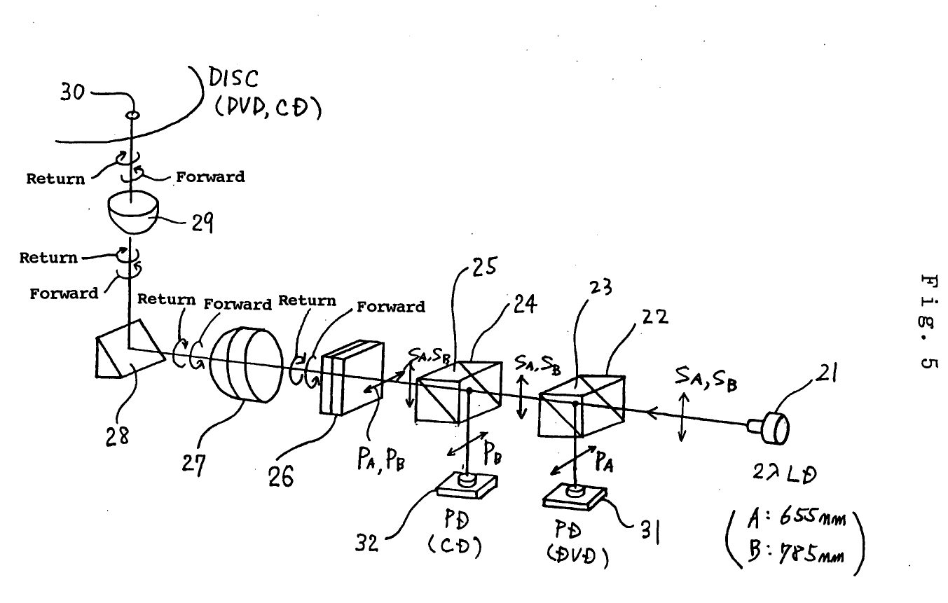

FIG. 5 is a perspective view showing the optical pickup according to one embodiment of the present invention.

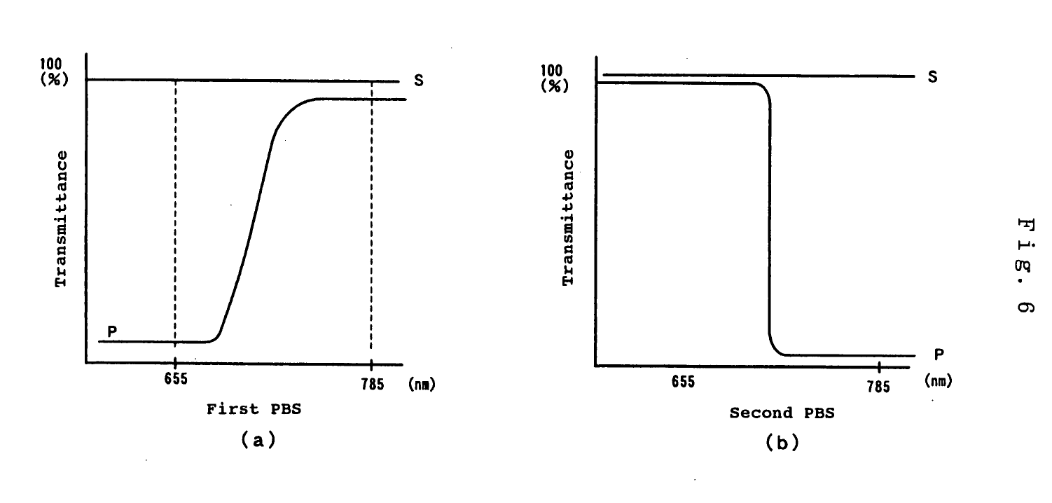

First, reproduction from DVD (655 nm) is explained. A linearly polarized light SA (S-polarized light) of 655 nm is emitted from a 2λLD 21 having a light source capable of emitting light of 655 nm and 785 nm, and enters a first PBS 22. Since an optical thin film having transmitting characteristics as shown in FIG. 6(a) is formed on an incline 23 of the first PBS 22, the linearly polarized light SA transmits through the incline 23 so as to enter a second PBS 24. Since an optical thin film having transmitting characteristics as shown in FIG. 6(b) is formed on an incline 25 of the second PBS 24, the linearly polarized light SA transmits through the incline 25 so as to enter a wide-band ¼ wave plate 26. A phase of the linearly polarized light SA shifts by 90°, and the linearly polarized light SA is emitted as circularly polarized light. The circularly polarized light passes through a collimating lens 27 and is reflected by a reflecting mirror 28. The circularly polarized light passes through an objective lens (hereinafter, OBJ) 29 so as to be emitted onto a pit 30 of DVD.

When the circularly polarized light is reflected from the pit 30, its rotational direction is inverted, and the circularly polarized light passes through the OBJ 29 and is reflected by the reflecting mirror 28 so as to enter the ¼ wave plate 26 via the collimating lens 27. Since the rotational direction of the circularly polarized light on a forward path is opposite to the rotational direction on a return path, the circularly polarized light is emitted as a linearly polarized light PA (P-polarized light). The linearly polarized light PA enters the second PBS 25 and transmits therethrough due to the characteristics of the optical film formed on the incline 25. The transmitted linearly polarized light PA enters the first PBS 22, and since the optical film which does not allow the P-polarized light of 655 nm to transmit therethrough is formed on the incline 23, the linearly polarized light PA is reflected by the incline 23 so as to be detected by a PD 31.

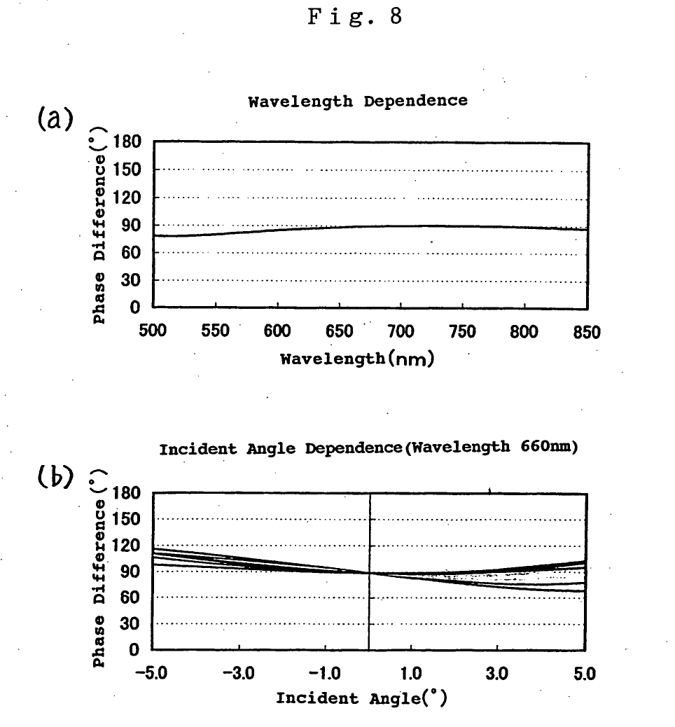

Next, reproduction from CD (785 nm) is explained below. A linearly polarized light SB (S-polarized light) of 785 nm is emitted from the 2λLD 21 and enters the first PBS 22. Since the optical film having transmitting characteristics as shown in FIG. 8(a) is formed on the incline 23 of the first PBS 22, the linearly polarized light SB transmits through the incline 23 and enters the second PBS 24 where an optical film having transmitting characteristics as shown in FIG. 8(b) is formed on the incline 25 so as to enter the wide-band ¼ wave plate 26. A phase of the linearly polarized light SB shifts by 90° so as that the linearly polarized light SB is emitted as circularly polarized light. The circularly polarized light passes through the collimating lens 27, is reflected by the reflecting mirror 28, and passes through the OBJ 29 so as to be emitted to the pit 30 of CD.

When the circularly emitted light is reflected by the pit 30, its rotational direction is inverted, and the circularly polarized light passes through the OBJ 29 so as to be reflected by the reflecting mirror 28. The circularly polarized light enters the ¼ wave plate 26 via the collimating lens 27. Since the rotational direction of the circularly polarized light on a forward path is opposite to the rotational direction of on a return path, the circularly polarized light is emitted as a linearly polarized light PB (P-polarized light), so as to enter the second PBS 24. Since the optical thin film which does not allow the P-polarized light of 785 nm to transmit is formed on the incline 25 of the second PBS 24, the linearly polarized light PB is reflected by the incline 25 so as to be detected by the PD 32.

With such a constitution, the optical pickup unit in which one-system pick-up deals with two wavelengths can be realized.

The smaller optical pickup unit which is compatible with DVD and CD and deals with two wavelengths can be, therefore, provided.

Further, since the incident angle dependence of the wide-band ¼ wave plate of the present invention is remarkably improved, it functions as a ¼ wave plate sufficiently for divergent light. For this reason, the wide-band ¼ wave plate can be arranged before the collimating lens viewed from a direction of the light source by taking the above advantage. Accordingly, an outside dimension of the wide-band ¼ wave plate can be compact, thereby contributing downsizing of the optical pickup unit.

As explained above, the following excellent effects can be obtained by the present invention.

According to the first aspect of the present invention, a wave plate whose phase difference is α with respect to a monochromatic light of a wavelength λ and a wave plate whose phase difference is β are laminated so that their optical axes cross. A relationship between the phase difference a and the phase difference β satisfies:
α=πn
β=πm/2
however, n>1, and m>1
   a material of one wave plate is a film having birefringence characteristics, and a material of the other wave plate is quarts. For this reason, the laminated wave plate, which functions as the wide-band ¼ wave plate and in which the incident angle dependence is remarkably improved, can be provided.

According to the second and the third aspects of the present invention, the laminated wave plate, which functions as the wide-band ¼ wave plate and in which the incident angle dependence is remarkably improved, is used. For this reason, a compact pickup which deals with a plurality of wavelengths can be provided.

According to the fourth aspect of the present invention, the quarts wave plate whose phase difference is 90° with respect to wavelength of 785 nm and the film wave form whose phase difference is 180° are laminated so that their optical axes cross. For this reason, the laminated wave plate, which functions as the wide-band ¼ wave plate and in which the incident angle dependence is remarkably improved, can be provided.

According to the fifth aspect of the present invention, the quarts wave plate whose phase difference is 90° with respect to wavelength of 785 nm and the film wave form whose phase difference is 90° are laminated so that their optical axes cross. For this reason, the laminated wave plate, which functions as the wide-band ¼ wave plate and in which the incident angle dependence is remarkably improved, can be provided.

1. A laminated wave plate in which a wave plate whose phase difference is α with respect to a monochromatic light of a wavelength λ and a wave plate whose phase difference is β are laminated so that their optical axes cross, and which functions as ¼ wave plate, wherein
a relationship between the phase difference α and the phase difference β satisfies the following condition:
α=πn
β=πm/2
however, n>1, and m>1
a material of one wave plate is a film having birefringence characteristics and a material of the other wave plate is quarts.

2. An optical pickup constituted so that a first linearly polarized light of a first wavelength and a second linearly polarized light of a second wavelength emitted from a light source pass through a wave plate, wherein
the wave plate is a laminated wave plate in which a wave plate whose phase difference is α with respect to a monochromatic light of a wavelength λ and a wave plate whose phase difference is β are laminated so that their optical axes cross, and which the laminated wave plate functions as ¼ wave plate, a relationship between the phase difference a and the phase difference β satisfies the following condition:
α=πn
β=πm/2
however, n>1, and m>1
a material of one wave plate is a film having birefringence characteristics and a material of the other wave plate is quarts.

3. The optical pickup according to claim 2, wherein the first wavelength is 655 nm, and the second wavelength is 785 nm.

4. A laminated wave plate in which a quarts wave plate whose phase difference is 90° with respect to wavelength 785 nm and a film wave plate whose phase difference is 180° are laminated so that their optical axes cross and the laminated wave plate functions as a ¼ wave plate.

5. A laminated wave plate in which a quarts wave plate whose phase difference is 90° with respect to wavelength 785 nm and a film wave plate whose phase difference is 90° are laminated so that their optical axes cross and the laminated wave plate functions as a ¼ wave plate.
